(19) United States
(12) Patent Application Publication
(10) Pub. No.: US 2013/0166849 A1
(43) Pub. Date: Jun. 27, 2013

(54) Physically Remote Shared Computer Memory

(71) Applicants: Bruce L. Beukema, Hayfield, MN (US); Patrick M. Bland, Raleigh, NC (US); Randolph S. Kolvick, Durham, NC (US); James A. Marcella, Rochester, MN (US); Makoto Ono, Cary, NC (US); Paul G. Reuland, Rochester, MN (US)

(72) Inventors: Bruce L. Beukema, Hayfield, MN (US); Patrick M. Bland, Raleigh, NC (US); Randolph S. Kolvick, Durham, NC (US); James A. Marcella, Rochester, MN (US); Makoto Ono, Cary, NC (US); Paul G. Reuland, Rochester, MN (US)

(73) Assignee: INTERNATIONAL BUSINESS MACHINES CORPORATION, ARMONK, NY (US)

(21) Appl. No.: 13/525,002

(22) Filed: Jun. 15, 2012

Related U.S. Application Data
(63) Continuation of application No. 13/334,237, filed on Dec. 22, 2011.

(51) Int. Cl. G06F 12/00

(52) U.S. Cl. 711/147; 711/E12.001

(57) ABSTRACT

A computing system with physically remote shared computer memory, the computing system including: a remote memory management module, a plurality of computing devices, a plurality of remote memory modules that are external to the plurality of computing devices, and a remote memory controller, the remote memory management module configured to partition the physically remote shared computer memory amongst a plurality of computing devices; each computing device including a computer processor and a local memory controller, the local memory controller including: a processor interface, a local memory interface, and a local interconnect interface; each remote memory controller including: a remote memory interface and a remote interconnect interface, wherein the remote memory controller is operatively coupled to the data communications interconnect via the remote interconnect interface such that the remote memory controller is coupled for data communications with the local memory controller over the data communications interconnect.

### CROSS-REFERENCE TO RELATED APPLICATION

This application is a continuation application of and claims priority from U.S. patent application Ser. No. 13/334,237, filed on Dec. 22, 2011.

### BACKGROUND OF THE INVENTION

1. Field of the Invention

The field of the invention is data processing, or, more specifically, methods, apparatus, and products for physically remote shared computer memory.

2. Description Of Related Art

Modern computing systems are becoming increasingly complex. As complexity of the tasks carried out by modern computing systems increases, modern computing systems need to be more flexible. One way to increase the flexibility of a computing system is to increase the resources available to computing components with the computing system beyond those resources that physically reside within each computing component.

### SUMMARY OF THE INVENTION

A computing system with physically remote shared computer memory, the computing system including: a remote memory management module, a plurality of computing devices, a plurality of remote memory modules that are external to the plurality of computing devices, and a remote memory controller, the remote memory management module configured to partition the physically remote shared computer memory amongst a plurality of computing devices; each computing device including a computer processor and a local memory controller, the local memory controller including: a processor interface, a local memory interface, and a local interconnect interface; each remote memory controller including: a remote memory interface and a remote interconnect interface, wherein the remote memory controller is operatively coupled to the data communications interconnect via the remote interconnect interface such that the remote memory controller is coupled for data communications with the local memory controller over the data communications interconnect.

The foregoing and other objects, features and advantages of the invention will be apparent from the following more particular descriptions of example embodiments of the invention as illustrated in the accompanying drawings wherein like reference numbers generally represent like parts of example embodiments of the invention.

### BRIEF DESCRIPTION OF THE DRAWINGS

FIG. 1 sets forth a block diagram of automated computing machinery comprising an example computer useful in managing physically remote memory in a computing system according to embodiments of the present invention.

FIG. 2 sets forth a block diagram of an example memory controller according to embodiments of the present invention.

FIG. 3 sets forth a block diagram of computing device configured to use of physically remote memory in accordance with embodiments of the present invention.

FIG. 4 sets forth a block diagram of a computing system with physically remote shared computer memory according to embodiments of the present invention.

FIG. 5 sets forth a flow chart illustrating an example method for accessing physically remote memory in a computing system according to embodiments of the present invention.

FIG. 6 sets forth a flow chart illustrating an example method for managing physically remote memory in a computing system according to embodiments of the present invention.

### DETAILED DESCRIPTION OF EXAMPLE EMBODIMENTS

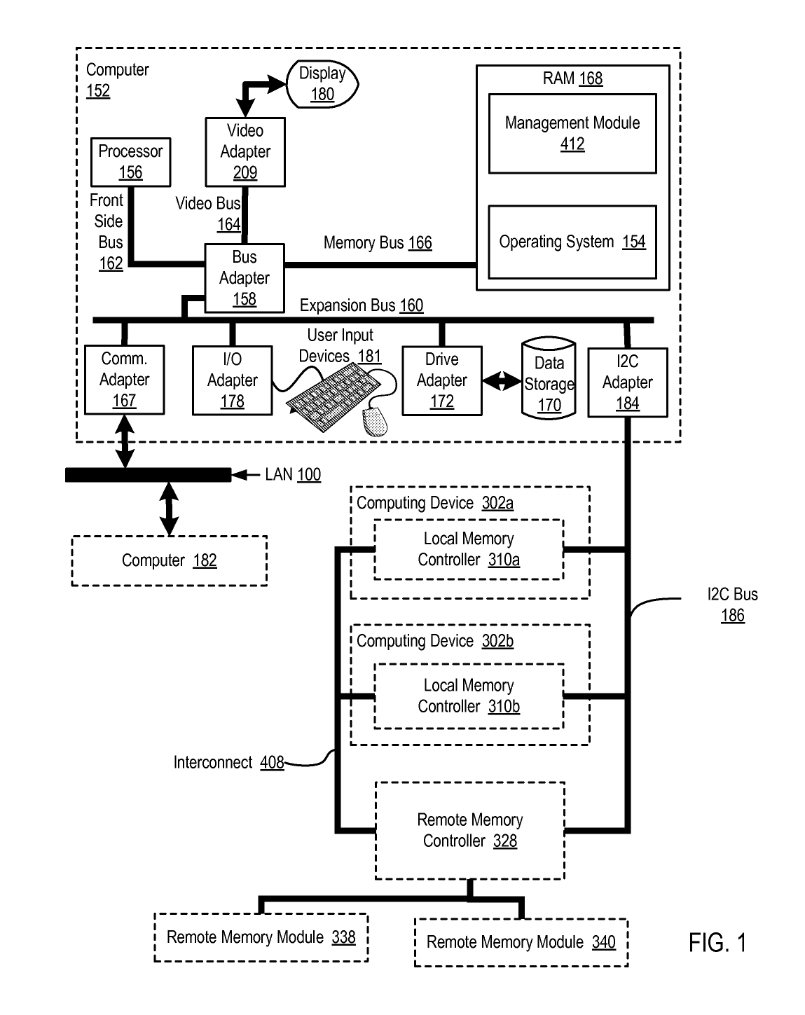

Example methods, apparatus, and products for managing and accessing physically remote memory in a computing system in accordance with the present invention are described with reference to the accompanying drawings, beginning with FIG. 1. FIG. 1 sets forth a block diagram of automated computing machinery comprising an example computer (152) useful in managing physically remote memory in a computing system according to embodiments of the present invention. The computer (152) of FIG. 1 includes at least one computer processor (156) or ‘CPU’ as well as random access memory (168) (‘RAM’) which is connected through a high speed memory bus (166) and bus adapter (158) to processor (156) and to other components of the computer (152).

Stored in RAM (168) is a remote memory management module (412), a module of computer program instructions for managing physically remote memory in a computing system according to embodiments of the present invention. The remote memory management module (412) of FIG. 1 is configured to identify one or more computing devices (302a, 302b) in the computing system. Each computing device (302a, 302b) includes a computer processor and a local memory controller (310a, 310b). The local memory controller (310a, 310b) includes a processor interface to operatively couple the local memory controller to a computer processor in the computing device (302a, 302b). The local memory controller (310a, 310b) also includes a local memory interface to operatively couple the local memory controller (310a, 310b) to one or more memory modules in the computing device (302a, 302b). The local memory controller (310a, 310b) also includes a local interconnect interface to operatively couple the local memory controller (310a, 310b) to a data communications interconnect (408).

The remote memory management module (412) of FIG. 1 is also configured to identify one or more remote memory modules (338, 340) that are external to the one or more computing devices (302a, 302b). Each remote memory controller (328) includes a remote memory interface for operatively coupling the remote memory controller (328) to the remote memory modules (338, 340). The remote memory controller (328) also includes a remote interconnect interface for operatively coupling the remote memory controller (328) to the data communications interconnect (408). The remote memory modules (338, 340) of FIG. 1 may be embodied, for example, as RAM, non-volatile main memory, flash storage, or any combination thereof.

The remote memory management module (412) of FIG. 1 is also configured to manage the remote memory modules (338, 340) for use by one or more of the computing devices (302a, 302b) in the computing system. Managing the remote memory modules (338, 340) for use by one or more of the computing devices (302a, 302b) in the computing system may be carried out, for example, by maintaining a memory allocation table identifying which portions of memory in the remote memory modules (338, 340) are free and available for allocation to a particular computing device (302a, 302b), which portions of memory in the remote memory modules (338, 340) are unavailable for use, which portions of memory in the remote memory modules (338, 340) have been set aside for access by a particular computing device (302a, 302b), and so on.

In the example of FIG. 1, the remote memory management module (412) may be configured to communicate with the local memory controllers (310a, 310b) and the remote memory controller (328) over an I²C bus (186) coupled to the computer (152) via an I²C adapter (184). Although the example of FIG. 1 shows a specific implementation in which the remote memory management module (412) is configured to communicate with the local memory controllers (310a, 310b) and the remote memory controller (328) over an I²C bus (186) coupled to the computer (152) via an I²C adapter (184), readers will appreciate that other bus protocols or data communications links may be utilized in accordance with embodiments of the present invention.

Also stored in RAM (168) is an operating system (154). Operating systems useful managing physically remote memory in a computing system according to embodiments of the present invention include UNIX™, Linux™, Microsoft XP™, AIX™, IBM's i5/OS™, and others as will occur to those of skill in the art. The operating system (154) and remote memory management module (412) in the example of FIG. 1 are shown in RAM (168), but many components of such software typically are stored in non-volatile memory also, such as, for example, on a disk drive (170).

The computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for managing physically remote memory in a computing system according to embodiments of the present invention include Integrated Drive Electronics (‘IDE’) adapters, Small Computer System Interface (‘SCSI’) adapters, Serial Attached SCSI (‘SAS’), Serial ATA (‘SATA’), and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The example computer (152) of FIG. 1 includes a communications adapter (167) for data communications with other computers (182) and for data communications with a data communications network (100). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for managing physically remote memory in a computing system according to embodiments of the present invention include modems for wired dial-up communications, Ethernet (IEEE 802.3) adapters for wired data communications network communications, and 802.11 adapters for wireless data communications network communications.

The computer (152) of FIG. 1 illustrates one embodiment of a computer configured to support a management module (412). Readers will appreciate, however, that other computers configured in other ways may also be used to support the management module (412). In alternative embodiments, for example, the functionality carried out by the bus adapter (158) may be embedded within the processor (156) itself. Furthermore, components such as the video adapter (209) may be embodied as peripherals that are coupled to the expansion bus (160). The example of FIG. 1 is included for explanation and not limitation.

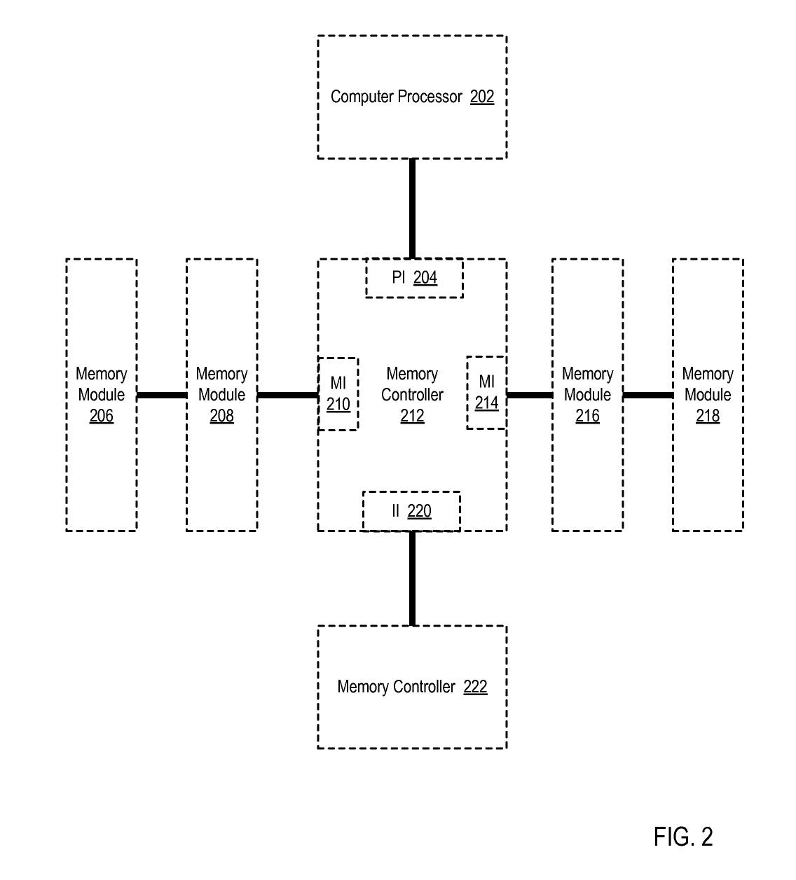

For further explanation, FIG. 2 sets forth a block diagram of an example memory controller (212) according to embodiments of the present invention. In the example of FIG. 2, the memory controller (212) is a module of automated computing machinery that facilitates the use of physical remote memory by a computing system. The memory controller of FIG. 2 may be embodied, for example, as an application-specific integrated circuit (‘ASIC’) that can include processors, memory, and so on.

In the example of FIG. 2, the memory controller (212) includes a processor interface (204). The processor interface (204) is an interface that allows the memory controller (212) to be coupled for data communications with a computer processor (202). The processor interface (204) can be used to couple the memory controller (212) to the computer processor (202), for example, over a QuickPath Interconnect (‘QPI’), front-side bus, or other interconnect configured to connect a computer processor to the memory controller (202).

In the example of FIG. 2, the memory controller (212) also includes one or more memory interfaces (210, 214). Each memory interface (210, 214) is an interface that allows the memory controller (212) to be coupled for data communications with one or more memory modules (206, 208, 216, 218). The memory modules (206, 208, 216, 218) of FIG. 2 may be embodied, for example, as dual in-line memory modules (‘DIMMs’), single in-line memory modules (‘SIMMs’), non-volatile main memory, flash storage devices, and so on. In such an example, the memory interface (210, 214) can couple the memory controller (212) for data communications with one or more memory modules (206, 208, 216, 218), for example, over memory bus such as a double data rate (‘DDR’) type one memory bus, DDR2 memory bus, DDR3 memory bus, DDR4 memory bus, single data rate (‘SDR’) memory bus, and so on.

In the example of FIG. 2, the memory controller (212) also includes an interconnect interface (220). The interconnect interface (220) is an interface that allows the memory controller (212) to be coupled for data communications over one or more data communications interconnects. Such a data communications interconnect may be embodied, for example, as a peripheral component interconnect express (‘PCIe’) bus comprising multiple lanes, a peripheral component interconnect (‘PCI’) bus, and so on. The data communications interconnect of FIG. 2 is memory coherent and may include switching elements for routing data communications. In the example of FIG. 2, the interconnect interface (220) and corresponding interconnect may be used to couple the memory controller (212) for point-to-point data communications with another interconnect endpoint, such as another memory controller (222).

Although not depicted in FIG. 2, readers will further appreciate that the memory controller (212) may also include an interface to couple the memory controller (212) to a general purpose computer that includes a remote memory management module as described above with reference to FIG. 1.

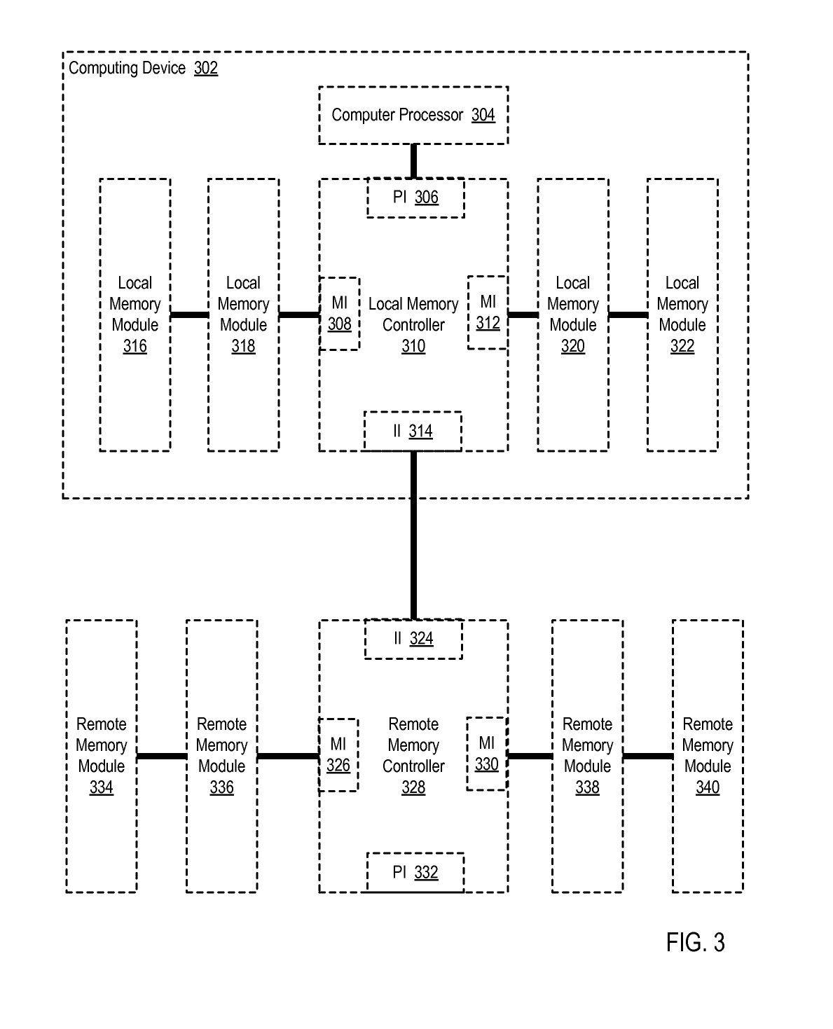

For further explanation, FIG. 3 sets forth a block diagram of computing device (302) configured to use of physically remote memory in accordance with embodiments of the present invention. In the example of FIG. 3, the computing device (310) may be embodied as a server, blade server mounted in a rack, and so on. The computing device (302) of FIG. 3 includes one or more computer processors (304), one or more local memory modules (316, 318, 320, 322), and one or more local memory controllers (310). In the example of FIG. 3, the local memory controllers (310) is similar to the memory controller (212) depicted in FIG. 2, as it includes many of the same interfaces such as a processor interface (306), memory interfaces (308, 312), and an interconnect interface (314). In the example of FIG. 3, the local memory controller (310) and the local memory modules (316, 318, 320, 322) are ‘local’ in the sense that the local memory controller (310) and the local memory modules (316, 318, 320, 322) reside within the physical structure of the computing device (310).

The example of FIG. 3 also includes a remote memory controller (328). The remote memory controller (328) of FIG. 3 is similar to the memory controller (212) depicted in FIG. 2, as the remote memory controller (328) includes many of the same interfaces such as the processor interface (332), an interconnect interface (324), and memory interfaces (326, 330). In the example of FIG. 3, however, the processor interface (332) of the remote memory controller (328) is not coupled to a computer processor.

In the example of FIG. 3, the remote memory controller (328) is coupled to multiple remote memory modules (334, 336, 338, 340) via the memory interfaces (326, 330) and one or more memory busses. The remote memory controller (328) and the remote memory modules (334, 336, 338, 340) of FIG. 3 are ‘remote’ in the sense that the remote memory controller (328) and the remote memory modules (334, 336, 338, 340) are not physically included within the computing device (302). The remote memory controller (328) and the remote memory modules (334, 336, 338, 340) exist entirely outside of the computing device (302) and can only be coupled to the computing device (302) through an interconnect that exists outside of the computing device (302).

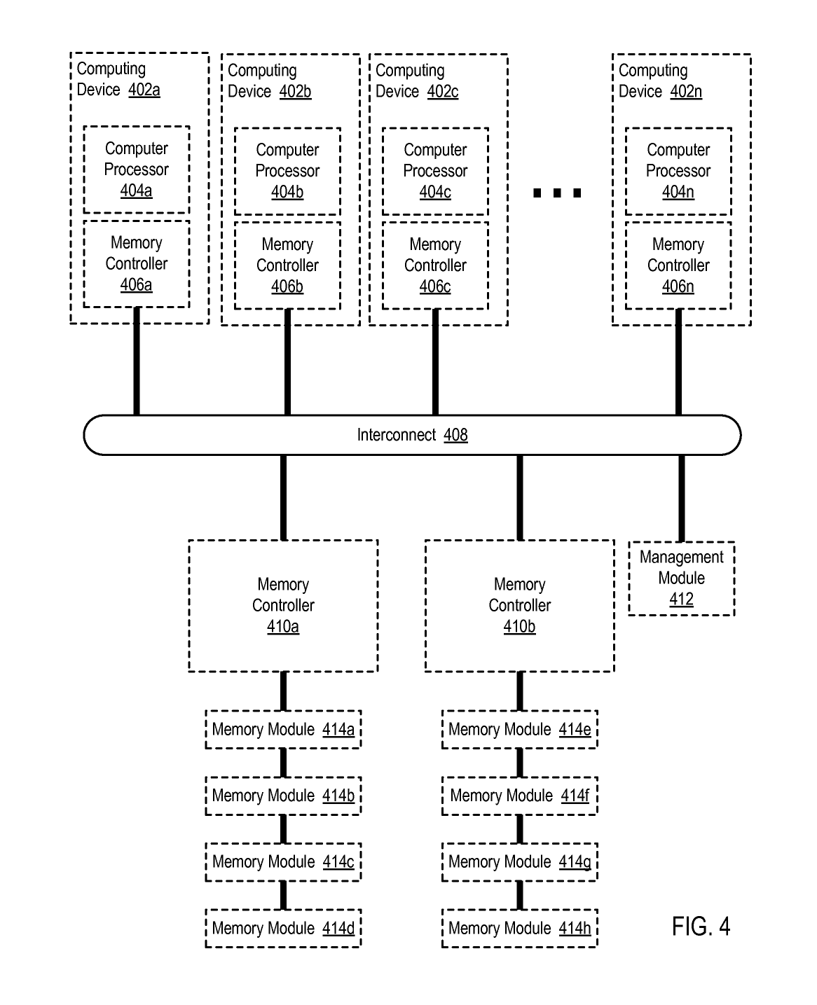

For further explanation, FIG. 4 sets forth a block diagram of a computing system with physically remote shared computer memory according to embodiments of the present invention. The computing system of FIG. 4 includes a plurality of computing devices (402a, 402b, 402c, 402n). The computing devices (402a, 402b, 402c, 402n) of FIG. 4 may be embodied, for example, as a stand-alone server, as a blade server in a blade center, and so on.

In the example of FIG. 4, each computing device (402a, 402b, 402c, 402n) includes a computer processor (404a, 404b, 404c, 404n) and a local memory controller (406a, 406b, 406c, 406n). Each local memory controller (406a, 406b, 406c, 406n) includes a processor interface such that the local memory controller (406a, 406b, 406c, 406n) of a computing device (402a, 402b, 402c, 402n) is operatively coupled to the computer processor (404a, 404b, 404c, 404n) of the computing device (402a, 402b, 402c, 402n) through the processor interface. Each local memory controller (406a, 406b, 406c, 406n) also includes a local memory interface such that the local memory controller (406a, 406b, 406c, 406n) of each computing device (402a, 402b, 402c, 402n) is operatively coupled to one or more local memory modules of each computing device (402a, 402b, 402c, 402n) via the local memory interface. Each local memory controller (406a, 406b, 406c, 406n) also includes a local interconnect interface such that the local memory controller (406a, 406b, 406c, 406n) of each computing device (402a, 402b, 402c, 402n) is operatively coupled to a data communications interconnect (408) via the local interconnect interface.

The computing system of FIG. 4 also includes a plurality of remote memory modules (414a, 414b, 414c, 414d, 414e, 414f, 414g, 414h) that are external to the plurality of computing devices (402a, 402b, 402c, 402n). The computing system of FIG. 4 also includes one or more remote memory controllers (410a, 410b). Each remote memory controller (410a, 410b) of FIG. 4 can include a remote memory interface such that each remote memory controller (410a, 410b) is operatively coupled to one or more of the remote memory modules (414a, 414b, 414c, 414d, 414e, 414f, 414g, 414h), such as a DIMM, via the remote memory interface. Each remote memory controller (410a, 410b) of FIG. 4 can also include a remote interconnect interface such that each remote memory controller (410a, 410b) is operatively coupled to the data communications interconnect (408) via the remote interconnect interface such that the remote memory controller (410a, 410b) is coupled for data communications with one or more local memory controllers (406a, 406b, 406c, 406n) over the data communications interconnect (408). In the example of FIG. 4, the data communications interconnect (408) may include switching elements for routing data communications between multiple computing devices (402a, 402b, 402c, 402n) and multiple memory controllers (410a, 410b). That is, the data communications interconnect (408) is not simply a point-to-point interconnect for coupling two devices but rather a many-to-many interconnect that couples many endpoints for data communications.

The computing system of FIG. 4 also includes a remote memory management module (412). The remote memory management module (412) of FIG. 4 may be embodied as a module of computer program instructions that, when executed, manages the configuration of a computing system with physically remote shared computer memory according to embodiments of the present invention. The remote memory management module (412) of FIG. 4 may be configured to manage the configuration of a computing system with physically remote shared computer memory, for example, by sending configuration information to the one or more memory controllers (406a, 406b, 406c, 410a, 410b). Such configuration information may include, for example, information identifying which computing device (402a, 402b, 402c, 402n) is configured to use a particular memory module (414a, 414b, 414c, 414d, 414e, 414f, 414g, 414h), what access privileges computing device (402a, 402b, 402c, 402n) has to a particular memory module (414a, 414b, 414c, 414d, 414e, 414f, 414g, 414h), and so on.

In the example of FIG. 4, the remote memory modules (414a, 414b, 414c, 414d, 414e, 414f, 414g, 414h) may serve as main memory for one or more of the computing devices (402a, 402b, 402c, 402n). Main memory refers to the program-addressable storage of the computing device (402a, 402b, 402c, 402n) that typically holds currently executing programs and their working data. Main memory is typically internal to a computer and often comprised of RAM. In embodiments of the present invention, however, the remote memory modules (414a, 414b, 414c, 414d, 414e, 414f, 414g, 414h) may also serve as main memory as memory access operations generated by the computer processor (404a, 404b, 404c, 404n) of a computing device (402a, 402b, 402c, 402n) may received by the local memory controller (406a, 406b, 406c, 406n) and passed to the remote memory controller (410a, 410b) over the data communications interconnect (408).

In the example of FIG. 4, each remote memory controller (410a, 410b) may also include a data compression engine. The data compression engine may be configured to compress data that is to be stored in the remote memory modules (414a, 414b, 414c, 414d, 414e, 414f, 414g, 414h). Compressing data reduces the size of memory that is required to store data and has the effect of increasing the size of memory. The data compression engine may also be configured to uncompress data that is read from the remote memory modules (414a, 414b, 414c, 414d, 414e, 414f, 414g, 414h).

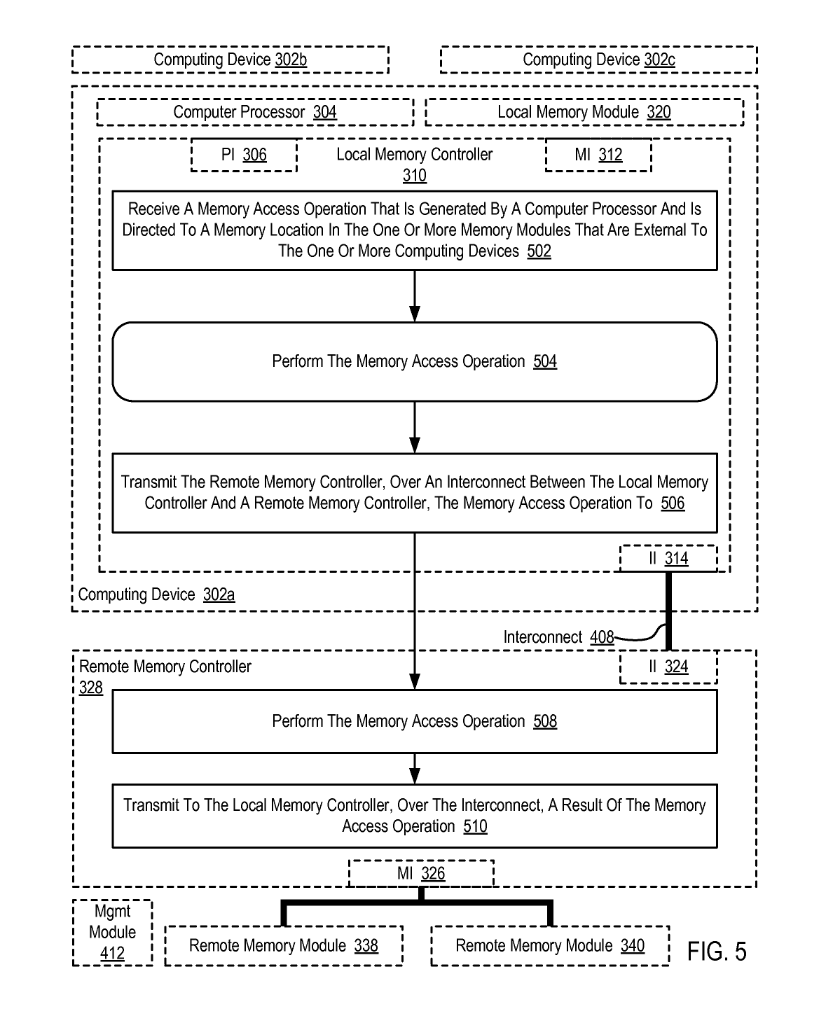

For further explanation, FIG. 5 sets forth a flow chart illustrating an example method for accessing physically remote memory in a computing system according to embodiments of the present invention. The computing system of FIG. 5 is similar to the computing systems described above with reference to FIGS. 2-4. The computing system of FIG. 5 includes a remote memory management module (412) and a plurality of computing devices (302a, 302b, 302c), although only a single computing device (302a) is shown in detail. The computing system of FIG. 5 also includes a plurality of remote memory modules (338, 340) that are external to the plurality of computing devices (302a, 302b, 302c) and a remote memory controller (328).

In the example method of FIG. 5, each computing device (302a, 302b, 303c) includes a computer processor (304) and a local memory controller (310). The local memory controller (310) includes a processor interface (306) to operatively couple the local memory controller (310) to the computer processor (304). The local memory controller (310) also includes a local memory interface (312) to operatively couple the local memory controller (310) to one or more local memory modules (320). The local memory controller (310) also includes a local interconnect interface (314) to operatively couple the local memory controller (310) to a data communications interconnect (408).

In the example method of FIG. 5, each remote memory controller (328) includes a remote memory interface (326) for operatively coupling the remote memory controller (328) to the remote memory modules (338, 340). The remote memory controller (328) also includes a remote interconnect interface (324) for operatively coupling the remote memory controller (328) to the data communications interconnect (408).

The example method of FIG. 5 includes receiving (502), by a local memory controller (310) in one of the computing devices (302a), a memory access operation. In the example method of FIG. 5, the memory access operation is generated by a computer processor (304) in the computing device (302a). The memory access operation represents an instruction to access some location in computer memory. The memory access operation may be embodied, for example, as a write operation that represents an instruction to write some data into a specified location in computer memory. The memory access operation may alternatively be embodied, for example, as a read operation that represents an instruction to read the data contained in a specified location in computer memory. In the example method of FIG. 5, the memory access operation is directed to a memory location in the one or more memory modules (338, 340) that are external to the one or more computing devices (302a, 302b, 302c). That is, the memory access operation represents an instruction to write data to a location in one or more of the remote memory modules (338, 340) or an instruction to read data from a location in one or more of the remote memory modules (338, 340).

The example method of FIG. 5 also includes transmitting (504), over an interconnect (408) between the local memory controller (310) and the remote memory controller (328) that is external to the one or more computing devices (302a, 302b, 302c), the memory access operation to the remote memory controller (328). In the example method of FIG. 5, the interconnect (408) may be embodied as one or more PCIe busses for operatively coupling the remote memory controller (310) to the local memory controller (328). In such an example, the memory access operation can be encapsulated into packets consistent with the PCIe bus protocol and transmitted across the PCIe bus from the local memory controller (310) to the remote memory controller (328). In the example of FIG. 5, the data communications interconnect (408) may include switching elements for routing data communications between multiple computing devices (402a, 402b, 402c, 402n) and multiple memory controllers (410a, 410b). That is, the data communications interconnect (408) is not simply a point-to-point interconnect for coupling two devices but rather a many-to-many interconnect that couples many endpoints for data communications.

The example method of FIG. 5 also includes performing (508), by the remote memory controller (328), the memory access operation. In the example method of FIG. 5, performing (508) the memory access operation may be carried out by executing the instruction contained in the memory access operation. In the example where the memory access operation is a write operation, the remote memory controller (328) may write data contained in the memory access operation to an address specified in the memory access operation. In the example where the memory access operation is a read operation, the remote memory controller (328) may read data contained in the address specified in the memory access operation.

The example method of FIG. 5 also includes transmitting (510), by the remote memory controller (328) over the interconnect (408), a result of the memory access operation to the local memory controller (310). In the example method of FIG. 5, the result of the memory access operation is dependent upon the nature of the memory access operation. For example, if the memory access operation is a write operation, the result of the write operation may simply be a response indicating that the write operation was successfully performed. If the memory access operation is a read operation, however, the result of the memory access operation may be the data that was contained in the memory location to be read from. In such an example, transmitting (510) the result of the memory access operation to the local memory controller (310) may be carried out by packetizing the result into a format consistent with the specification of the interconnect (408) and sending such packetized data from the remote memory controller (328) to the local memory controller (310).

The example method of FIG. 5 can optionally includes performing (504), by the local memory controller (310), the memory access operation. As described above, the memory access operation is directed to a memory location in the one or more memory modules (338, 340) that are external to the one or more computing devices (302a, 302b, 302c). Performing such a memory operation, however, introduces latencies that would not occur during an access of a local memory module (304), as there is no need to transmit the memory operation and its results over the interconnect (408). As such, it may be beneficial to locally cache the contents of the remote memory modules (338, 340) in the local memory modules (320) and have the local memory module (310) perform (504) the memory access operation as appropriate.

Consider an example in which the memory access operation is an instruction to write data into a location in memory of a remote memory module (338). In such an example, the local memory module (310) perform (504) the memory access operation by also writing the data into a location in memory of the local memory module (310). The address that the data was written to in the local memory module (310) could subsequently be associated with the address that the data is written to in the remote memory module (338) in an address translation table. In such an example, a future memory access operation that represented an instruction to read from the same address that the data is written to in the remote memory module (338) could be carried out locally by reading from the corresponding location in the local memory module (304).

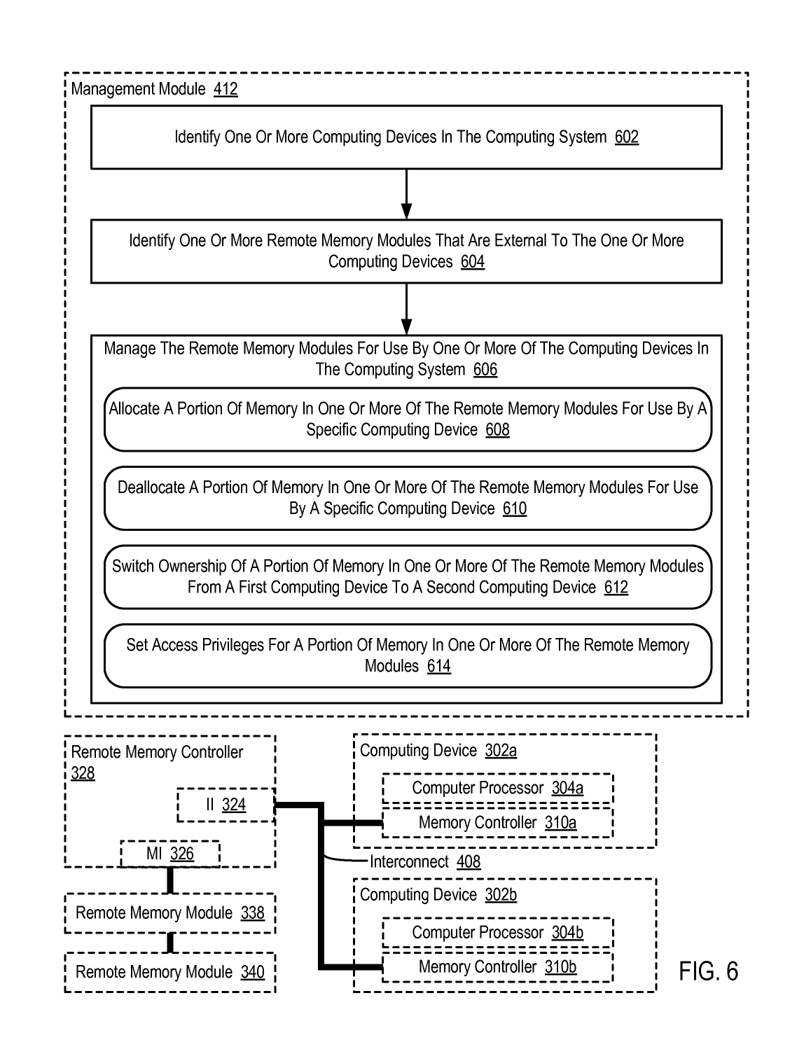

For further explanation, FIG. 6 sets forth a flow chart illustrating an example method for managing physically remote memory in a computing system according to embodiments of the present invention. The computing system of FIG. 6 is similar to the computing systems described above with reference to FIGS. 2-4. The computing system of FIG. 6 includes a remote memory management module (412) and a plurality of computing devices (302a, 302b). The computing system of FIG. 6 also includes a plurality of remote memory modules (338, 340) that are external to the plurality of computing devices (302a, 302b) and a remote memory controller (328).

In the example method of FIG. 6, each computing device (302a, 302b) includes a computer processor (304a, 304b) and a local memory controller (310a, 310b). The local memory controller (310a, 310b) includes a processor interface to operatively couple the local memory controller (310a, 310b) to the computer processor (304a, 304b). The local memory controller (310a, 310b) also includes a local memory interface to operatively couple the local memory controller (310a, 310b) to one or more local memory modules. The local memory controller (310a, 310b) also includes a local interconnect interface to operatively couple the local memory controller (310a, 310b) to a data communications interconnect (408).

In the example method of FIG. 6, each remote memory controller (328) includes a remote memory interface (326) for operatively coupling the remote memory controller (328) to the remote memory modules (338, 340). The remote memory controller (328) also includes a remote interconnect interface (324) for operatively coupling the remote memory controller (328) to the data communications interconnect (408).

The example method of FIG. 6 includes identifying (602), by the remote memory management module (412), one or more computing devices (302a, 302b) in the computing system. In the example method of FIG. 6, identifying (602) one or more computing devices (302a, 302b) in the computing system may be carried out, for example, by requiring that each computing device (302a, 302b) register with the remote memory management module (412) upon inclusion in the computing system, by periodically polling the computing system for computing devices (302a, 302b), through the receipt of user input identifying each computing device (302a, 302b), and so on.

The example method of FIG. 6 also includes identifying (604), by the remote memory management module (412), one or more remote memory modules (338, 340) that are external to the one or more computing devices (302a, 302b). In the example method of FIG. 6, identifying (604) one or more remote memory modules (338, 340) that are external to the one or more computing devices (302a, 302b) may be carried out, for example, by having each remote memory controller (328) report each connected remote memory module (338, 340) to the remote memory management module (412), by polling each remote memory controller (328) to identify each remote memory module (338, 340) that is connected to the remote memory controller (328), by receiving user input identifying each remote memory module (338, 340) that is connected to the remote memory controller (328), and so on.

The example method of FIG. 6 includes managing (606), by the remote memory management module (412), the remote memory modules (338, 340) for use by one or more of the computing devices (302a, 302b) in the computing system. Managing (606) the remote memory modules (338, 340) for use by one or more of the computing devices (302a, 302b) in the computing system may be carried out, for example, by maintaining a memory allocation table identifying which portions of memory in the remote memory modules (338, 340) are available for use, which portions of memory in the remote memory modules (338, 340) are unavailable for use, which portions of memory in the remote memory modules (338, 340) have been set aside for access by a particular computing device (302a, 302b), and so on.

In the example method of FIG. 6, managing (606) the remote memory modules (338, 340) for use by one or more of the computing devices (302a, 302b) in the computing system can include allocating (608), by the remote memory management module (412), a portion of memory in one or more of the remote memory modules (338, 340) for use by a specific computing device (302a, 302b). Allocating (608) a portion of memory in one or more of the remote memory modules (338, 340) for use by a specific computing device (302a, 302b) may be carried out, for example, by assigning a portion of memory in the remote memory modules (338, 340) that is currently available to a particular computing device (302a, 302b) for use by the computing device (302a, 302b). In such an example, the computing device (302a, 302b) may be notified with a message identifying the amount of memory that has been allocated (608) to the computing device (302a, 302b), the address range of memory that has been allocated (608) to the computing device (302a, 302b), and so on.

In the example method of FIG. 6, managing (606) the remote memory modules (338, 340) for use by one or more of the computing devices (302a, 302b) in the computing system can alternatively include deallocating (610), by the remote memory management module (412), a portion of memory in one or more of the remote memory modules (338, 340) for use by a specific computing device (302a, 302b). Deallocating (610) a portion of memory in one or more of the remote memory modules (338, 340) for use by a specific computing device (302a, 302b) may be carried out, for example, by making available a portion of memory in the remote memory modules (338, 340) that is currently allocated to a particular computing device (302a, 302b). In such an example, the portion of memory in the remote memory modules (338, 340) that is to be deallocated (610) may be placed into the pool of available memory, for example, by including the address range of the portion of memory in the remote memory modules (338, 340) that is to be deallocated (610) into a table identifying available memory.

In the example method of FIG. 6, managing (606) the remote memory modules (338, 340) for use by one or more of the computing devices (302a, 302b) in the computing system can alternatively include switching (612), by the remote memory management module (412), ownership of a portion of memory in one or more of the remote memory modules (338, 340) from a first computing device (302a) to a second computing device (302b). Switching (612) ownership of a portion of memory in one or more of the remote memory modules (338, 340) from a first computing device (302a) to a second computing device (302b) may be carried out, for example, by updating an allocation table to reassign a portion of memory in the remote memory modules (338, 340) that is currently available to a particular computing device (302a) to a different computing device (302b). In such an example, each computing device (302a, 302b) may be notified with a message identifying, for example, the address range of memory whose ownership has been switched (612), information identifying the current owner of the memory, and so on.

In the example method of FIG. 6, managing (606) the remote memory modules (338, 340) for use by one or more of the computing devices (302a, 302b) in the computing system can alternatively include setting (614), by the remote memory management module (412), access privileges for a portion of memory in one or more of the remote memory modules (338, 340). In the example method of FIG. 6, the access privileges for a portion of memory in one or more of the remote memory modules (338, 340) may stipulate how one or more computing devices (302a, 302b) may utilize the portion of memory. For example, the access privileges may stipulate that a first computing device (302a) has read-only access privileges, a second computing device (302b) has write-only access privileges, another device has read and write access privileges, and so on.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

1. A computing system with physically remote shared computer memory, the computing system including:
a remote memory management module, a plurality of computing devices, a plurality of remote memory modules that are external to the plurality of computing devices, and a remote memory controller, the remote memory management module configured to partition the physically remote shared computer memory amongst a plurality of computing devices;
each computing device including a computer processor and a local memory controller, the local memory controller including:
a processor interface, wherein the local memory controller is operatively coupled to the computer processor through the processor interface;
a local memory interface, wherein the local memory controller is operatively coupled to one or more local memory modules via the local memory interface; and
a local interconnect interface, wherein the local memory controller is operatively coupled to a data communications interconnect via the local interconnect interface;
each remote memory controller including:
a remote memory interface, wherein the remote memory controller is operatively coupled to the remote memory modules via the remote memory interface; and
a remote interconnect interface, wherein the remote memory controller is operatively coupled to the data communications interconnect via the remote interconnect interface such that the remote memory controller is coupled for data communications with the local memory controller over the data communications interconnect.

2. The computing system of claim 1 wherein the remote memory modules comprise main memory for one or more of the computing devices.

3. The computing system of claim 1 wherein the computing devices are servers.

4. The computing system of claim 1 wherein the remote memory modules are dual in-line memory modules (‘DIMMs’).

5. The computing system of claim 1 wherein the local processor interface includes a QuickPath Interconnect (‘QPI’) for operatively coupling the local memory controller to the one or more computer processors of the computing devices.

6. The computing system of claim 1 wherein the remote memory interface includes one or more memory busses for operatively coupling the remote memory controller to the remote memory modules.

7. The computing system of claim 1 wherein the data communications interconnect includes one or more peripheral component interconnect express (‘PCIe’) busses for operatively coupling the remote memory controller to the local memory controller.

8. The computing system of claim 1 wherein the remote memory controller is further configured to compress data to be stored in the remote memory modules.

9. The computing system of claim 1 wherein the remote memory controller is further configured to uncompress data read from the remote memory modules.

10-19. (canceled)
